(19) United States
(12) Patent Application Publication
(10) Pub. No.: US 2017/0349762 A1
(43) Pub. Date: Dec. 7, 2017

(54) WATER-BASED COATING AGENT COMPOSITION, WATER-BASED LUBRICATING FILM PAINT COMPOSITION COMPRISING SAME, AND MEMBER

(71) Applicant: Dow Corning Toray Co., Ltd., Tokyo (JP)

(72) Inventors: Takahiko SASAKI, Kanagawa (JP); Tetsuji YAMAGUCHI, Kanagawa (JP)

(21) Appl. No.: 15/534,582

(22) PCT Filed: Dec. 11, 2015
(86) PCT No.: PCT/JP2015/006200

§ 371 Date: Aug. 9, 2017

(30) Foreign Application Priority Data
Dec. 15, 2014 (JP) 2014-253518

(51) Int. Cl. C09D 5/02; C09D 7/12; C10M 107/04; C10M 107/44

(52) U.S. Cl. CPC C09D 5/02; C10M 107/44; C09D 7/12; C10M 107/04

(57) ABSTRACT

An aqueous coating agent composition includes (A) a curable resin in the form of an aqueous emulsion, (B) a surfactant, (C) solid particles, (D) one or more nitrogen-containing heterocyclic compounds, and (E) water. In various embodiments, component (C) includes a solid lubricant, and for reasons of environmental regulations, component (D) includes 1,3-dimethyl-2-imidazolidinone.

### TECHNICAL FIELD

The present invention relates to an aqueous coating agent composition. Further, the present invention is an application of said aqueous coating agent composition and relates to an aqueous lubricating film paint composition, and a member provided with a coating film or a lubricating film, obtained by curing the composition, along with a method for forming a coating/lubricating film.

### BACKGROUND ART

Aqueous paints or aqueous coating agents (hereinafter, “aqueous coating agents”) obtained by dispersing or emulsifying a curable resin in water contain an organic solvent as a film-forming assistant so as to form a film at low temperatures. In such an aqueous coating agent composition, a curable resin is often dispersed or emulsified in the form of an emulsion and mixed with a pigment or solid lubricant in the form of a powder, paste, or dispersion, with a surfactant for dispersing and stabilizing the powder and preventing precipitation also capable of being added to the mixture. These aqueous coating agents can be applied onto a substrate of metal, rubber, plastic, etc. and cured, thereby yielding a member provided with the desired function of a coating film.

For example, Patent Documents 1 to 4 disclose a method for forming a lubricating film on a metal substrate surface, specifically a cooling tube drawing method of a tube stock with a lubricating film formed therein, in which the lubricating film can be formed on the tube stock by dispersing or suspending a composition in a solvent containing water using a curable resin such as a polyacryl resin, fine particles such as a solid lubricant, and a surfactant such as wax particles, applying the composition to the tube stock via immersion, etc., passing it through a drying belt of 60 to 150° C., etc. Moreover, Patent Documents 1 to 4 disclose that it is preferable to use water or a solvent containing at least water in order to form a tough resin layer, with examples of solvents other than water potentially including alcohols, ether-based solvents, acetate-based solvents, ketone-based solvents, hydroxy amines, and dimethyl sulfoxide, and examples of solvents containing at least water potentially including mixed solvents consisting of water and the abovementioned solvents other than water, for example, water-alcohol-based solvents consisting of water and the abovementioned alcohols, etc. Note that the surfactant may be any component to disperse the abovementioned resin and wax particles, and dodecylbenzenesulfonate, etc. is not specifically disclosed.

In contrast, Patent Documents 1 to 4 exemplify, as the abovementioned ketone solvent, acetone, methyl ethyl ketone, methyl isobutyl ketone, 2-pyrrolidone, N-methyl-2-pyrrolidone, N-methyl-3-methyl-2-pyrrolidone, 1,3-dimethyl-2-imidazolidinone, N, N-dimethylformamide, etc., but do not describe or suggest using a mixed solvent among nitrogen-containing heterocyclic compounds and water. Further, Patent Documents 1 to 4 exemplify, as the abovementioned ketone solvent: ketone solvents that generally cause demulsification and destabilize aqueous coating agent compositions for the case in which a mixed solvent of acetone, etc. and water is formed; and nitrogen-containing heterocyclic compounds, with no distinction between the two. Patent Documents 1 to 4 do not exhibit any technical problems in terms of the stability of the aqueous coating agent, and further do not provide any suggestions regarding the resolution means.

### PRIOR ART DOCUMENTS

### Patent Documents

Patent Document 1: Japanese Unexamined Patent Application Publication No. 2007-268580
Patent Document 2: Japanese Unexamined Patent Application Publication No. 2007-268584
Patent Document 3: Japanese Unexamined Patent Application Publication No. 2007-268587
Patent Document 4: Japanese Unexamined Patent Application Publication No. 2006-143988

### SUMMARY OF THE INVENTION

### Problems to be Solved by the Invention

In contrast, the present inventors have found new technical problems regarding the aqueous coating agent as mentioned above. In known aqueous coating agents, a curable resin is an aqueous emulsion resin composition that is synthesized via emulsion polymerization, emulsifier (soap) free emulsion polymerization, etc.; however, for the case in which a surfactant is added into the system in order to stably disperse solid particles such as solid lubricants, the curable resin in the form of an emulsion may interact with the surfactant, destabilize the surface state of the curable resin, cause thickening and gelation, and significantly impair fluidity (that is, the coating properties). In contrast, if a surfactant is not added, solid particles such as solid lubricants form precipitates in the aqueous coating agent, impair storage stability, and render the entire aqueous coating agent incapable of being uniformly coated, potentially making it impossible to obtain a coating film having the desired function.

The present invention has been created in order to solve the abovementioned problems, with the object of providing an aqueous coating agent composition which contains a curable resin emulsified or dispersed in water, along with a surfactant for uniformly dispersing solid particles in water, and can suppress the interaction between the curable resin and the surfactant, suppress thickening/gelation or disproportionation throughout the aqueous coating agent, improve overall fluidity, coating properties and storage stability, and form a favorable coating film. In addition, it is also the object to provide a member provided with the coating film, along with a method for forming the coating film.

Further, the object of the present invention is to provide an aqueous lubricating film paint composition that can form a film having the sliding properties of high adhesion, a low friction coefficient, and favorable abrasion resistance on the surface of various substrates by drying, etc. using a solid lubricant as at least part of the solid particles, and thereby form a lubricating film that can maintain superior sliding properties for extended periods of time. In addition, it is also the object to provide a lubricating film, a sliding member provided with the lubricating film, and a method for forming the lubricating film, using the lubricating film paint composition.

### Means for Solving the Problems

As a result of extensive research in order to solve the abovementioned problems, the present inventors have found that the abovementioned problems can be solved by an aqueous coating agent composition, including (A) a curable resin in the form of an aqueous emulsion, (B) a surfactant, (C) solid particles, (D) one or more nitrogen-containing heterocyclic compounds, and (E) water. Further, the present inventors have found that by blending a solid lubricant as at least part of component (C), a lubricating film, formed on substrate surfaces using the composition, has superior sliding properties, and moreover, has superior sliding durability, leading to the present invention.

That is, the first object of the present invention is achieved by an aqueous coating agent composition, including:

(A) a curable resin in the form of an aqueous emulsion;
(B) a surfactant;
(C) solid particles;
(D) one or more nitrogen-containing heterocyclic compounds; and
(E) water.
In the aqueous coating agent composition of the present invention, component (D) may be a nitrogen-containing heterocyclic compound represented by any one of the below mentioned structural formulae (D-1) to (D-3).

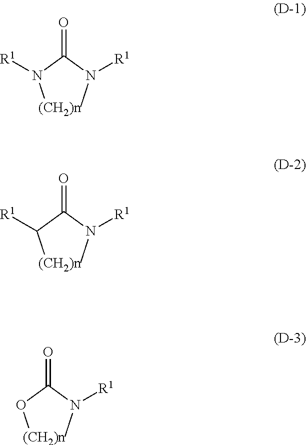

(wherein R¹ is a hydrogen atom or each independently an alkyl group having a carbon number of 1 to 9, and n is a number in the range of 1 to 10).

More suitably, component (D) is preferably one or more nitrogen-containing heterocyclic compounds selected from 1,3-dimethyl-2-imidazolidinone, N-methyl-2-pyrrolidone, N-ethyl-2-pyrrolidone, N-methyl-3-methyl-2-pyrrolidone, cyclohexyl pyrrolidone, 2-oxazolidone, and 3-methyl-2-oxazolidone.

In particular, for the case in which component (B) contains an anionic surfactant different from the surfactant used for the emulsion formation of component (A), component (D) is preferably 1,3-dimethyl-2-imidazolidinone.

The aqueous coating agent composition of the present invention preferably contains, with respect to 100 as the product mass of solid content of component (A) prior to a curing reaction, 0.1 to 50 parts by mass of component (B), 5 to 200 parts by mass of component (C), 1 to 20 parts by mass of component (D), and 50 to 1000 parts by mass of component (E).

Component (A) is more preferably a polyacryl resin, a polyurethane resin, a polyolefin resin, an epoxy resin, a silicone resin, a polyamide-imide resin, in the form of an aqueous emulsion, or a modified product thereof or a mixture thereof.

Component (C) preferably contains a solid lubricant selected from a fluorine resin, a polyethylene resin, a polyamide resin, molybdenum disulfide, graphite, aluminum oxide, boron nitride, zinc oxide, or a mixture thereof. When containing such a solid lubricant, the aqueous coating agent composition of the present invention can be suitably used as an aqueous lubricating film paint composition.

The present invention relates to a coating film obtained by curing the abovementioned aqueous coating agent composition. Note that the coating film of the present invention may be used as a lubricating film.

The present invention relates to a member provided with a coating film, obtained by curing the abovementioned aqueous coating agent composition. The member may be used as a sliding member.

The present invention relates to a method for forming a coating film on a substrate surface, including: applying the abovementioned aqueous coating agent composition onto a substrate surface; and drying and/or irradiating it with high energy rays. The method may be used for a method for manufacturing a sliding member by forming a lubricating film on the substrate surface.

### Effects of the Invention

The aqueous coating agent of the present invention suppresses the interaction between the curable resin in the form of an aqueous emulsion and the surfactant added to disperse solid particles, suppresses thickening/gelation or disproportionation throughout the aqueous coating agent, and improves the fluidity, coating properties, and storage stability thereof. As a result, the aqueous coating agent of the present invention can be stored for extended periods and a uniform coating film having superior physical properties of the film and superior adhesion to a substrate can be formed. In addition, the present invention can provide a member provided with the coating film, along with a method for forming the coating film.

Further, the present invention can provide an aqueous lubricating film paint composition that can form a film having the sliding properties of high adhesion, a low friction coefficient, and favorable abrasion resistance on the surface of various substrates by drying, etc. using a solid lubricant as at least part of the solid particles, and thereby form a lubricating film that can maintain superior sliding properties for extended periods of time. In addition, using the lubricating film paint composition, a lubricating film, a sliding member provided with the lubricating film, and a method for forming the lubricating film can be provided.

Note that because component (D) is a component that functions as a film-forming assistant, a tough resin layer can be formed more easily than known aqueous coating agent compositions, thereby expectedly improving the physical strength of a coating film or lubricating film, along with the adhesion and production efficiency.

Further, taking into consideration the environment and human body, even for the case in which an amide-based solvent such as N-methyl pyrrolidone (NMP) must not to be used as component (D), when a compound such as 1,3-dimethyl-2-imidazolidinone is used, a solvent that tends not to adversely affect the environment and human body is used, and an aqueous coating agent composition that stably flows and has superior handling workability can be provided, and in particular, product designs corresponding to European environmental regulations can be achieved.

### BEST MODE FOR CARRYING OUT THE INVENTION

The first aspect of the present invention is an aqueous coating agent composition, including:

(A) a curable resin in the form of an aqueous emulsion;
(B) a surfactant;
(C) solid particles;
(D) one or more nitrogen-containing heterocyclic compounds; and
(E) water.
Hereinafter, each of the components will be described.

### Component (A)

Component (A) is a curable resin in the form of an aqueous emulsion and is a main agent of the aqueous coating agent composition according to the present invention, forms a coating film by curing, and functions, for example, as a solid particle binder resin. In particular, the curable resin in the form of an aqueous emulsion is a curable resin composition synthesized by emulsion polymerization, soap-free emulsion polymerization, etc. and obtained by dispersing a curable resin component in water in a continuous phase, with examples thereof potentially including a polyacryl resin, a polyurethane resin, a polyolefin resin, an epoxy resin, a silicone resin, a polyamide-imide resin, or a modified product thereof or a mixture thereof.

Typically, the curable resin thereof in the form of an aqueous emulsion can be obtained by emulsifying or dispersing a polymerizable curable resin monomer or a prepolymer in water in the presence or absence of a surfactant, and carrying out emulsion polymerization of the monomer or prepolymer by heating, etc. Through emulsion via the action of the surfactant, or self-emulsification via the introduction of a hydrophilic group to a curable resin, the curable resin obtained by the emulsion polymerization takes a form in which fine particles of the minute curable resin are emulsified and dispersed in water, and assumes an appearance generally suspended or opacified.

Such resin particles in a dispersion state of an emulsion take the form of an aqueous emulsion and are generally easily handled, allowing an advantageous reduction in the environmental load in that a film can be formed simply by removing water by drying, etc. compared with dosage forms that use an organic solvent. In contrast, resin particles obtained by emulsion polymerization have high reactivity derived from unreacted monomers or residual reactive functional groups, with mixing of other components, in particular, other surfactants, as well as mixing of hydrophilic/hydrophobic solid particles tending to easily impair a uniform emulsion state. Specifically, this refers to the thickening or gelation of a resin emulsion disproportionation caused by the generation of bulky particles with time, along with progress of the polymerization reaction between resin particles.

The curable resin thereof in the form of an aqueous emulsion can be synthesized by known methods and is preferably a curable resin in the form of an aqueous emulsion, obtained by emulsion polymerization in water using a surfactant, in particular, an ionic surfactant. Moreover, while the particle diameter of the curable resin particles in an emulsion is not particularly limited, the particle diameter (median diameter) obtained by laser diffraction/scattering methods is preferably approximately 0.1 to 10 μm, and the appearance may be in the form of an opacified liquid or suspension.

The polyacryl resin in the form of an aqueous emulsion is the form of an aqueous emulsion or a suspension polymerization liquid, and may be a homopolymer or a copolymer as long as it can be obtained by polymerizing one or two or more acryl-based monomers. Moreover, the structure and kind thereof are not particularly limited. Examples of the abovementioned acryl-based monomer may include one or two or more alkyl(meth)acrylates (having an alkyl group with a carbon number of preferably 1 to 8, more preferably 1 to 6, particularly preferably 1 to 4) such as methyl(meth)acrylate, ethyl(meth)acrylate, isopropyl(meth)acrylate, n-butyl(meth)acrylate, 2-ethylhexyl(meth)acrylate, and octyl(meth)acrylate; lower alkoxy lower alkyl(meth)acrylates such as methoxymethyl(meth)acrylate, methoxyethyl(meth)acrylate, ethoxymethyl(meth)acrylate, ethoxyethyl(meth)acrylate, and methoxybutyl(meth)acrylate; hydroxy lower alkyl(meth)acrylates such as 2-hydroxy ethyl(meth)acrylate and 3-hydroxy propyl(meth)acrylate; acrylamide, methacrylamide; (meth)acrylamides having an N-unsubstituted or substituted (in particular, lower alkoxy substituted) methylol group such as N-methylolacrylamide, N-methylolmethacrylamide, N-butoxymethylacrylamide, and N-butoxymethylmethacrylamide; phosphonyloxy lower alkyl(meth)acrylates such as phosphonyloxymethyl(meth)acrylate, phosphonyloxyethyl(meth)acrylate, and phosphonyloxypropyl(meth)acrylate; acrylonitrile; acrylic acid; methacrylic acid, etc. Note that the abovementioned lower alkoxy and the abovementioned lower alkyl generally refer to alkoxy and alkyl each having a carbon number of 1 to 5, preferably a carbon number of 1 to 4, more preferably 1 to 3.

Here, the polyacryl resin may include a (meth)acrylic acid compound having a (meth) acrylic equivalent of 100 or smaller, preferably 95 or smaller, more preferably 90 or smaller as a component configuring the hard segment of the cured product, and a (meth)acrylic acid compound having a (meth)acrylic equivalent of 120 to 300, preferably 130 to 270, more preferably 150 to 250 as a component configuring the soft segment of the cured product, along with other curable resins (for example, a polyurethane resin, etc.), in order to further improve adhesion to various substrates. The present applicants propose the use of such a polyacryl resin or a mixture with other curable resins as in International Patent Application PCT/JP14/061806.

The kind of the polyurethane resin is not particularly limited, with the polyurethane resin obtained by reacting at least one polyol and at least one isocyanate being preferable. Note that a polyurethane resin in the form of an aqueous emulsion may be self-emulsifiable by the introduction of a hydrophilic group, and may be a form emulsified and dispersed in water via an ionic surfactant, in particular, an anionic surfactant such as carboxylic acid triethyl amine salt.

As long as it has two or more hydroxyl groups in one molecule, the polyol is not particularly limited, with conventionally known polyols capable of being used. Examples thereof may include polyester polyols, polycarbonate polyols, polyether polyols, polycaprolactone polyols, polyalkylene polyols, etc. Polyols may be used alone, or two or more thereof may be used in combination.

Example polyester polyols may include polyester polyols obtained by condensation polymerization of polycarboxylic acid and polyol. Example polycarboxylic acids may include dicarboxylic acids such as succinic acid, terephthalic acid, isophthalic acid, dodecanedioic acid, 1,5-naphthalic acid, 2,6-naphthalic acid, succinic acid, glutaric acid, adipic acid, pimelic acid, suberic acid, azelaic acid, sebacic acid, dodecamethylene dicarboxylic acid, etc. As the polycarboxylic acid, linear dicarboxylic acid is preferable. The carbon number of the linear dicarboxylic acid is preferably 4 or more, more preferably 4 to 12. Moreover, the carbon number of linear dicarboxylic acid is particularly preferably an even number. Specific examples of such linear dicarboxylic acids may include succinic acid, adipic acid, suberic acid, sebacic acid, dodecanedioic acid, etc. Moreover, example polyols may include propylene glycol, 1,3-propanediol, 1,4-butanediol, neopentyl glycol, 1,5-pentanediol, 1,6-hexanediol, ethylene glycol, diethylene glycol, cyclohexanediol, etc. The polycarboxylic acid and polyol may each be used alone, or two or more thereof may be used in combination. The hydroxyl value of polyester polyol is preferably 2 to 160 mgKOH/g.

Polycarbonate polyol is a compound having a repeating unit represented by the formula: —R—O(C═O)O— (wherein R represents a bivalent aliphatic or cycloaliphatic hydrocarbon group having a carbon number of 2 to 5), along with two or more hydroxyl groups, examples thereof potentially including polyhexamethylene carbonate polyol, polycyclohexanedimethylene carbonate polyol, etc.

Polycarbonate diol is a compound having the abovementioned repeating unit and two hydroxyl groups in a molecule. Polycarbonate diol can be synthesized from aliphatic and/or cycloaliphatic diol via various methods described in Polymer Review, Vol. 9, pages 9 to 20 (in 1964), written by Schell. Examples of preferable diols may include ethylene glycol, 1,2-propanediol, 1,3-propanediol, 1,2-butanediol, 1,3-butanediol, 1,4-butanediol, neopentyl glycol, 2,3-butanediol, 1,5-pentanediol, 1,6-hexanediol, 2,5-hexanediol, 1,4-cyclohexanediol, 1,4-cyclohexanedimethanol, etc.

The range of the average molecular weight of polycarbonate diol to be used is generally a number average molecular weight of 500 to 5000, preferably 1000 to 3000, and substantially all polymer terminals thereof are desirably hydroxyl groups. In the present invention, in addition to the abovementioned diols, polycarbonate, which is multifunctionalized using a small amount of a compound having three or more hydroxyl groups in one molecule, for example, trimethylolethane, trimethylolpropane, hexanetriol, pentaerythritol, etc., may be used.

Example polyether polyols may include polyethylene glycol, polypropylene glycol, polytetramethylene glycol, random copolymers and block copolymers thereof, and polyoxyalkylene modified products of bisphenol A.

Example polycaprolactone polyols may include polycaprolactone polyols obtained by ring-opening addition polymerization of a lactone compound to polyol. Example polyols may include the same as the abovementioned polyol in polyester polyol. Moreover, example lactone compounds may include β-propiolactone, pivalolactone, δ-valerolactone, ç-caprolactone, methyl-ε-caprolactone, dimethyl-ε-caprolactone, trimethyl-ε-caprolactone, etc.

Example polyalkylene polyols may include polybutadiene polyol, hydrogenated polybutadiene polyol, hydrogenated polyisoprene polyol, etc.

As the polyol, polyester polyol or polycarbonate polyol is preferable, polycarbonate polyol is more preferable, and polycarbonate diol is further preferable.

As long as the isocyanate includes an isocyanate group in one molecule, it is also not particularly limited, with conventionally known ones potentially used. As the isocyanate, polyisocyanate having two or more isocyanate groups in one molecule is preferable. Isocyanates may be used alone, or two or more thereof may be used in combination.

Example polyisocyanates may include 4,4′-diphenylmethane diisocyanate (4,4′-MDI), 2,4-diphenylmethane diisocyanate (2,4-MDI), 2,2′-diphenylmethane diisocyanate (2,2′-MDI), carbodiimide-modified diphenylmethane diisocyanate, polymethylenepolyphenyl polyisocyanate, carbodiimidized diphenylmethane polyisocyanate, tolylene diisoocyanate (TDI, 2,4-TDI, 2,6-TDI, or a mixture thereof), xylylene diisocyanate (XDI), 1,5-naphthalene diisocyanate (NDI), tetramethylxylene diisocyanate, phenylene diisocyanate, hexamethylene diisocyanate (HDI), dimer acid diisocyanate, norbornene diisocyanate, lysine diisocyanate, xylylene diisocyanate, tetramethylxylylene diisocyanate, isophorone diisocyanate (IPDI), hydrogenated diphenylmethane diisocyanate (hydrogenated MDI), hydrogenated xylylene diisocyanate (hydrogenated XDI), cyclohexane diisocyanate, dicyclohexylmethane diisocyanate, isophorone diisocyanate, etc.

As the polyisocyanate, diisocyanates or triisocyanates are preferable. Example diisocyanates or triisocyanates may include isophorone diisocyanate, tolylene diisocyanate, 4,4′-diphenylmethane diisocyanate, naphthylene diisocyanate, xylylene diisocyanate, phenylene diisocyanate, 3,3′-dichloro-4,4′-phenylmethane diisocyanate, tolylene diisocyanate, hexamethylene diisocyanate, 4,4′-dicyclohexylmethane diisocyanate, hydrogenated xylylene diisocyanate, triphenylmethane triisocyanate, tetramethylxylene diisocyanate, hydrogenated 4,4′-diphenylmethane diisocyanate, etc.

The polyurethane resin in the form of an aqueous emulsion according to the present invention is more preferably a polycarbonate-based urethane resin obtained by reacting polycarbonate polyol and diisocyanate.

A polyolefin resin, an epoxy resin, and a polyamide-imide resin in the form of an aqueous emulsion may be obtained, for example, by a method for emulsifying these curable resins synthesized by a known method, in the presence of a surfactant, by mechanical means. A silicone resin in the form of an aqueous emulsion can be obtained by emulsifying and dispersing a silicone resin synthesized in advance similarly to above, and also by carrying out emulsion polymerization of a silane monomer or a low-molecular weight chain or cyclic silicone oligomer in the presence of a surfactant.

Example polyolefin resins may include an olefin copolymer of a polyethylene resin, polypropylene resin, etc., and in particular, a copolymer of these and other vinyl-based monomers. Further, in terms of the storage stability of the aqueous emulsion, the monomer sequence of an olefin copolymer is particularly preferably random (atactic).

The epoxy resin is not particularly limited, with one or more capable of being selected and used from among a bisphenol-type epoxy resin, an amine-type epoxy resin, a phenol novolak-type epoxy resin, a cresol novolak-type epoxy resin, a resorcinol-type epoxy resin, a phenolaralkyl-type epoxy resin, a naphthol aralkyl-type epoxy resin, a dicyclopentadiene-type epoxy resin, an epoxy resin having a biphenyl skeleton, an isocyanate-modified epoxy resin, a tetraphenylethane-type epoxy resin, a triphenylmethane-type epoxy resin, a fluorene-type epoxy resin, etc.

The polyamide resin is a synthetic resin having an amide bond, and generally, one that can be obtained by a condensation reaction between a polybasic acid having two or more carboxyl groups and polyamine having two or more amino groups can be used. Example polybasic acids may include succinic acid, glutaric acid, adipic acid, sebacic acid, phthalic acid, isophthalic acid, terephthalic acid, trimellitic acid, tetrahydrophthalic acid, end methylenetetra hydrophthalic acid, hexahydrophthalic acid, etc. In contrast, example polyamines may include hydrazine, methylenediamine, ethylenediamine, propylenediamine, butylenediamine, hexanediamine, ethylaminoethylamine, methylaminopropylamine, iminobispropylamine, diethylene triamine, triethylene tetramine, polyethyleneimine, diaminobenzene, triaminobenzene, diaminoethylbenzene, triaminoethylbenzene, diaminoethylbenzene, triaminoethylbenzene, polyaminonaphthalene, polyaminoethylnaphthalene, and N-alkyl derivatives or N-acyl derivatives thereof, etc. Polyamide resins may be used alone, or two or more thereof may be used in combination.

Example methods of dispersion or emulsion in order to obtain the curable resin in the form of an aqueous emulsion may include known emulsion methods. Example emulsion methods may include high-pressure emulsion methods using mechanical force, reverse emulsion methods, ultrasonic emulsion methods, solvent emulsion methods, etc. Note that for the case in which the curable resin is not self-emulsifiable, a surfactant that is the same as or different from the below mentioned surfactant is used, and the curable resin is preferably emulsified or dispersed in water.

The curable resin in the form of an aqueous emulsion contains water as a dispersal medium, in addition to the curable resin and any surfactant component; wherein, for the case in which the curable resin in the form of an aqueous emulsion is used as a component of the aqueous coating agent composition, a part or all thereof is contained in water, which is component (E).

### Component (B)

Component (B) is a surfactant and is a component for uniformly dispersing solid particles, which are component (C), in the aqueous coating agent composition. Even when solid particles, in particular solid particles which are a solid lubricant, are generally lacking in water dispersibility despite hydrophilic treatment, etc. having been carried out on the surface thereof; for the case in which component (B) is not used, solid particles, which are component (C), are separated or sedimented from the aqueous coating agent composition, making it difficult to obtain a uniform aqueous coating agent.

In contrast, as mentioned above, the surfactant and solid particles added into the system may impair the dispersion stability of the curable resin in the form of an aqueous emulsion. Component (B) in the present invention may be the same surfactant as that used for the formation of the curable resin in the form of an aqueous emulsion, or may be a different surfactant from that used for the formation of the curable resin in the form of an aqueous emulsion. This is because, for the case in which the resin emulsion can be formed as in a self-emulsifiable polyurethane resin even without using a surfactant, when the surfactant is added into the system in order to disperse solid particles, the surface of the curable resin may interact with the surfactant, thereby impairing the dispersion state thereof. In the present invention, particularly suitably, the surfactant, which is component (B), is a different surfactant from that used for the emulsion formation of component (A), and preferably, specifically contains an ionic surfactant and more specifically contains an anionic surfactant.

The kind of surfactant of component (B) is not particularly limited, with any of a nonionic surfactant, an anionic surfactant, an amphoteric surfactant, and a cationic surfactant capable of being used. Example nonionic surfactants may include polyoxy ethylene alkyl ether; polyoxy alkylene (ethylene and/or propylene)alkyl phenyl ether; polyoxy ethylene alkyl ester consisting of polyethylene glycol (or ethylene oxide) and higher fatty acids (for example, linear or branched fatty acids having a carbon number of 12 to 18); polyoxy ethylene sorbitan alkyl ester consisting of sorbitan, polyethylene glycol, and higher fatty acids (for example, linear or branched fatty acids having a carbon number of 12 to 18), etc. Example anionic surfactants may include a fatty acid salt, a sulfate ester salt, sulfonate, a phosphate ester salt, a dithiophosphate ester salt, etc. Example amphoteric surfactants may include amino acid-type and betaine-type carboxylic salts, sulfate ester salts, sulfonate, phosphate ester salts, etc. Example cationic surfactants may include aliphatic amine salts, quaternary ammonium salts, etc. Surfactants may be used alone, or two or more thereof may be used in combination.

Specific example anionic surfactants may include surfactants such as potassium oleate, sodium laurate, sodium dodecylbenzenesulfonate, sodium alkanesulfonate, sodium alkyl naphthalene sulfonate, sodium dialkyl sulfosuccinate, polyoxyethylene alkyl ether sodium sulfonate, polyoxyethylene alkylallyl ether sodium sulfate, polyoxyethylene alkyl phosphate ester, and polyoxyethylene alkylallyl phosphate ester.

Specific example cationic surfactants may include surfactants such as stearylamine hydrochloride, lauryltrimethyl ammonium chloride, and trimethyloctadecyl ammonium chloride. Specific example nonionic surfactants may include surfactants such as polyoxyethylene alkyl ether, polyoxyethylene alkylallyl ether, a polyoxyethylene oxypropyl block polymer, polyethylene glycol fatty acid ester, and polyoxyethylene sorbitan fatty acid ester.

### Component (C)

Component (C) is solid particles, which are components imparting a desired function to the aqueous coating agent of the present invention. While the kind of solid particles is not particularly limited, examples thereof may include functional particles such as solid lubricants, reinforcing fillers, thickeners, abrasion-resistant agents, pigments, coloring materials, ultraviolet ray absorbents, thermally-conductive fillers, conductive fillers, and insulating materials. Note that part of the particles can be blended as multiple functional particles.

For the case in which the aqueous coating agent of the present invention is used as the aqueous lubricating film paint composition, at least part of component (C) is preferably a solid lubricant. When containing a solid lubricant, the composition of the present invention enables a lubricating film to be formed on a substrate surface, and moreover, the lubricating film can maintain superior sliding properties for extended periods of time. Accordingly, the composition of the present invention can yield a lubricating film having high adhesion and superior sliding durability as the lubricating film paint composition.

While the solid lubricant is not particularly limited, one solid lubricant may be used, or two or more solid lubricants may be used in combination. Specific examples thereof may include molybdenum disulfide, tungsten disulfide, calcium stearate, mica, black lead, polytetrafluoroethylene (PTFE), other lubricating resins, a composite oxide (SrₓCa₁₋ₓCuO_{y}, etc.) having an oxygen defect perovskite structure, etc. Other examples may include fine particles that suppress direct contact between metals without significantly reducing the friction coefficient, with a burning-prevention effect potentially expected, and the fine particles including carbonates (carbonate of alkali metals or alkali earth metals such as Na₂CO₃, CaCO₃, and MgCO₃), silicates (MₓO_{y}SiO₂[M: alkali metal, alkali earth metal], etc.), metal oxides (oxide of a typical metal element, oxide of a transition metal element, composite oxide containing these metal elements [Al₂O₃/MgO, etc.], etc.), sulfides (PbS, etc.), fluorides (CaF₂, BaF₂, etc.), carbides (SiC, TiC), nitrides (TiN, BN, AlN, Si₃N₄, etc.), cluster diamonds, fullerene C₆₀, mixtures of fullerene C₆₀ and C₇₀, etc. Examples of the abovementioned typical metal elements may include Al₂O₃, CaO, ZnO, SnO, SnO₂, CdO, PbO, Bi₂O₃, Li₂O, K₂O, Na₂O, B₂O₃, SiO₂, MgO, In₂O₃, etc. Among others, the typical metal elements thereof are preferably alkali earth metals, aluminum, or zinc. Examples of the abovementioned oxide of transition metal elements may include oxides such as TiO₂, NiO, Cr₂O₃, MnO₂, Mn₃O₄, ZrO₂, Fe₂O₃, Fe₃O₄, Y₂O₃, CeO₂, CuO, MoO₃, Nd₂O₃, H₂O₃, etc.

Preferred example solid lubricants may include fine particles of organic compounds including fluorine resins (in particular, polytetrafluoroethylene, tetrafluoroethylene hexafluoropropylene copolymer, etc.), polyethylene resins, and polyamide resins; fine particles of inorganic compounds such as molybdenum disulfide, graphite, aluminum oxide, boron nitride, and zinc oxide; fine particles of metals such as lead; and mixtures thereof. In particular, it is preferable to use at least one solid lubricant selected from a fluorine resin, a polyethylene resin, a polyamide resin, molybdenum disulfide, graphite, aluminum oxide, boron nitride, zinc oxide, and mixtures thereof. Note that for the case in which resin particles are used as the solid lubricant, they do not need to be in the form of an emulsion, unlike component (A).

The average particle diameter of the solid lubricant is preferably 15 μm or smaller, more preferably 0.2 to 10 μm. Note that the average particle diameter used herein refers to the volume average particle diameter measured using a laser diffraction particle size distribution measurement apparatus.

The reinforcing filler is a component to impart mechanical strength to a film obtained by curing the aqueous coating agent of the present invention, thereby improving the performance as a protective agent or adhesive. Examples of such a reinforcing filler may include inorganic fillers such as fumed silica fine powder, sedimentary silica fine powder, burned silica fine powder, fumed titanium dioxide fine powder, quartz fine powder, calcium carbonate fine powder, diatomaceous earth fine powder, aluminum oxide fine powder, aluminum hydroxide fine powder, zinc oxide fine powder, and zinc carbonate fine powder; wherein these inorganic fillers may contain inorganic fillers subjected to surface treatment using a treating agent including organoalkoxy silanes such as methyltrimethoxysilane, organohalosilanes such as trimethylchlorosilane, organosilazanes such as hexamethyldisilazane, and siloxane oligomers such as an α,ω-silanol group hindered dimethyl siloxane oligomer, an α,ω-silanol group hindered methylphenyl siloxane oligomer, and an α,ω-silanol group hindered methylvinyl siloxane oligomer. Note that part of silica, etc. functions as a thickener or an abrasion-resistant agent.

Examples of solid particles as a thermally-conductive filler or a conductive filler may include metal fine powders such as gold, silver, nickel, and copper; fine powders obtained by depositing or plating metals such as gold, silver, nickel, and copper on the surface of fine powders such as ceramics, glass, quartz, and an organic resin; and metal compounds such as aluminum oxide, aluminum nitride, and zinc oxide, along with mixtures of two or more thereof. Particularly suitable examples thereof include silver powder, aluminum powder, aluminum oxide powder, zinc oxide powder, aluminum nitride powder, or graphite. Moreover, for the case in which electrical insulating properties are necessary, metal oxide-based powder or metal nitride-based powder is preferable, with aluminum oxide powder, zinc oxide powder, or aluminum nitride powder being particularly preferable.

Other solid particles may include coloring agents, for example, pigment [inorganic coloring agent (inorganic pigment)] achromatic colors, or chromatic colors (yellow, orange, red, purple, blue, green, etc.). Moreover, examples of solid particles having various functions such as ultraviolet ray absorbency (or blocking properties) may include metal oxides (or metal oxide particles) such as titanium oxide and zinc oxide. In particular, when imparting a coloring or ultraviolet ray-resistant coating function to the coating film of the present invention, these components are preferably contained.

Examples of solid particles other than these may include metal hydroxides (aluminum hydroxide, etc.); metal salts (sulfate; carbonates such as calcium carbonate; phosphates such as calcium phosphate and titanium phosphate; silicates such as mica, calcium silicate, bentonite, zeolite, granite porphyry, talc, and montmorillonite; tungstates such as calcium tungstate; titanates such as barium titanate, potassium titanate, aluminum titanate, and strontium titanate); metal nitrides (silicon nitride, boron nitride, aluminum nitride, titanium nitride, etc.), metal carbides (silicon carbide, boron carbide, titanium carbide, tungsten carbide, etc.); metal borides (titanium boride, zirconium boride, etc.); metals (gold, platinum, palladium, etc.); carbons (carbon black, black lead, fullerene, carbon nanotube, etc.); fillers such as a silicone resin-based filler, a fluorine resin-based filler, and a polybutadiene resin-based filler, etc. Solid particles may take a fiber shape (for example, glass fibers, carbon fibers, metal fibers, whisker, etc.), etc., with a powder particle shape preferable. Solid particles may be ferromagnetic bodies, for example, ferromagnetic metals (powder) such as iron, cobalt, and nickel; ferromagnetic alloys (powder) such as magnetite and ferrite; ferromagnetic metal oxides (powder) such as magnetic iron oxide, etc. Example silicone resin-based fillers may include “TREFIL” produced by Dow Corning Toray Co., Ltd., “SPM” produced by Wacker Asahikasei Silicone Co., Ltd., etc.

While the shape of solid particles is not particularly limited, any shape such as a particle shape, a plate shape, a needle shape, and a fiber shape can be used. For the case in which the shape of solid particles is anisotropic such as a plate shape, a needle shape, or a fiber shape, the aspect ratio thereof is 1. 5 or more, 5 or more, or 10 or more.

### Component (D)

Component (D) is one or more nitrogen-containing heterocyclic compounds, which are characteristic components of the present invention, and is a hydrophilic solvent that mixes with (E) water, while simultaneously functioning as a film-making assistant of aqueous coating agent compositions.

For the case in which a surfactant is added into the system in order to stably disperse solid particles such as the abovementioned solid lubricant in the aqueous coating agent composition, the curable resin in the form of an emulsion may interact with the surfactant, destabilize the surface state of the curable resin, cause thickening and gelation, and significantly impair fluidity (that is, the coating properties). In contrast, if a surfactant is not added, solid particles such as solid lubricants form precipitates in the aqueous coating agent, impair storage stability, and render the entire aqueous coating agent incapable of being uniformly coated, potentially making it impossible to obtain a coating film having a desired function. However, the use of component (D) of the present invention enables the interaction with the surfactant in the system to be mitigated and enables (A) the curable resin in the form of an aqueous emulsion and (C) solid particles to be stably dispersed in water, suppressing gelation and the formation of bulky particles. Further, as mentioned above, component (D) is a film-making assistant, and can impart a uniform and tough coating film during curing. Moreover, one component (D) may be used, or if needed, two or more thereof maybe mixed and used.

Structurally, component (D) is a 4 to 20-membered cyclic heterocyclic compound containing one or more nitrogen atoms in the cyclic portion, with the carbon atom adjacent to nitrogen preferably configuring part (C═O) of a ketone group. Moreover, in terms of affinity with (E) water and function as a film-making assistant, a 4 to 13-membered cyclic, 4 to 8-membered cyclic, or 4 to 6-membered cyclic heterocyclic compound containing one or two or more nitrogen atoms is preferable, with preferred examples thereof potentially including a pyrrolidone compound, an imidazolidinone compound, or an oxazolidone compound, each of which has a ketone group and is a 5-membered ring heterocyclic compound containing one or two or more nitrogens.

In contrast, unexpectedly, even when a heterocyclic compound that does not contain nitrogen (N) in the cyclic portion, for example, a lactone-based compound, is used, the technical effects of the present invention cannot be achieved. Similarly, even when one (for example, acetone and methylethyl ketone) that is a ketone solvent but does not correspond to the nitrogen-containing heterocyclic compound is used, the technical effects of the present invention are not achieved, and on the contrary, demulsification, etc. may significantly adversely affect the stability of the aqueous coating agent composition. Accordingly, the selection of a nitrogen-containing heterocyclic compound is essential for achieving the specific and significant technical effects of the present invention, and it is difficult to predict the technical effects from compounds having a similar structure.

Specific example nitrogen-containing heterocyclic compounds, which is component (D), may include a heterocyclic compound containing two nitrogen atoms represented by the below mentioned structural formula (D-1), or a heterocyclic compound containing one nitrogen atom represented by the below mentioned structural formula (D-2).

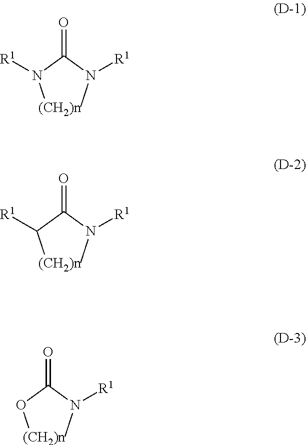

In the above formula, R¹ is a hydrogen atom or each independently an alkyl group having a carbon number of 1 to 9, with examples thereof potentially including a hydrogen atom; and a linear, branched chain or cyclic alkyl group such as a methyl group, an ethyl group, a hexyl group, or a cyclohexyl group. Note that part of the hydrogen atom of an alkyl group may be substituted for a halogen atom. n is a number in the range of 1 to 10, preferably in the range of 1 to 5, and most preferably 2 or 3, that is, a 5-membered ring structure or a 6-membered ring structure.

In the present invention, particularly suitable component (D) is one or more nitrogen-containing heterocyclic compounds selected from 1,3-dimethyl-2-imidazolidinone, N-methyl-2-pyrrolidone, N-ethyl-2-pyrrolidone, N-methyl-3-methyl-2-pyrrolidone, cyclohexylpyrrolidone, 2-oxazolidone, and 3-methyl-2-oxazolidone. Particularly suitably, it is a pyrrolidone compound or imidazolidinone compound, represented by the above formula (D-1) or (D-2) among nitrogen-containing heterocyclic compounds having a 5-membered ring structure, wherein n=2. Specific examples thereof include 1,3-dimethyl-2-imidazolidinone, N-methyl-2-pyrrolidone, and N-ethyl-2-pyrrolidone, with 1,3-dimethyl-2-imidazolidinone particularly preferable.

Further, component (D) represented by the below mentioned structural formula containing 1,3-dimethyl-2-imidazolidinone may be selected in terms of environmental regulations. Hereinafter, the reasons therefore will be described.

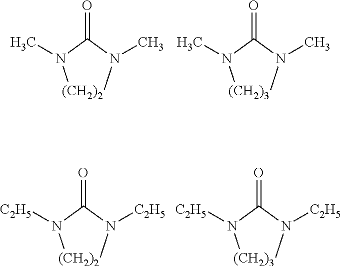

From the viewpoint of a film-forming assistant, amide-based solvents such as N-methylpyrrolidone (NMP), N,N-dimethyl acetamide, and N,N-dimethyl formamide are solvents having superior handling workability because they plasticize aqueous emulsion resins extremely well and have a high boiling point along with a low freezing point. However, the abovementioned amide-based solvents reportedly have reproductive toxicity in the European zone, necessitating that attention be paid to the handling of amide-based solvents around Europe including the handling of application films, along with residual solvents in structures. In particular, taking into consideration the environment and human body, amide-based solvents tend not to be used in Europe, necessitating that amide-based solvents such as N-methyl pyrrolidone (NMP) not to be used.

In contrast, when the abovementioned compounds such as 1,3-dimethyl-2-imidazolidinone are used, an aqueous coating agent composition that stably flows and has superior handling workability can be provided using a solvent that tends not to adversely affect the environment and human body. From the viewpoint of resolving environmental regulations, the most suitable component (D) is 1,3-dimethyl-2-imidazolidinone.

### Component (E)

Component (E) is water, and is a dispersal medium of the aqueous coating agent composition according to the present invention. Water may be brought into the system as a dispersal medium of the curable resin in the form of an aqueous emulsion, which is the abovementioned component (A), or may be brought into the system as an aqueous solution of the surfactant, which is component (B). Moreover, in addition to the abovementioned component (D), as long as water does not impair the object of the present invention, it may be mixed with other below mentioned water-soluble optional components and other hydrophilic solvents such as alcohol in advance.

### Composition of the Aqueous Coating Agent

The aqueous coating agent of the present invention contains the abovementioned components (A) to (E); and suitably, with respect to 100 as the product weight of solid content of component (A), component (B) can be 0.1 to 50 parts by weight, 0.5 to 50 parts by weight, or 1 to 50 parts by weight, preferably 2 to 40 parts by weight, further preferably 5 to 35 parts by weight; component (C) can be 5 to 200 parts by weight, preferably 20 to 180 parts by weight, further preferably 40 to 150 parts by weight; component (D) can be 1 to 20 parts by weight, preferably 2 to 15 parts by weight, further preferably 5 to 10 parts by weight; and component (E) can be 50 to 1000 parts by weight, preferably 100 to 800 parts by weight, further preferably 300 to 600 parts by weight. Note that the “solid content of component (A)” used herein is a nonvolatile component for the case in which water or other volatile components is/are removed from component (A) by drying or heating, which is mainly made of a main agent of the curable resin or the nonvolatile curable resin itself.

### Other Water-Soluble Optional Components

As long as the aqueous coating agent composition of the present invention does not impair the technical effects of the present invention, such as the stability of the abovementioned curable resin in the form of an aqueous emulsion, the handling workability, and the function of the obtained coating film, the composition may contain a lame agent, a pearl agent, an antiseptic agent, a perfume, a plasticizer, an anti-foam agent, a filler, an antioxidant, an ultraviolet ray absorbent, a curing agent, a catalyst, a solvent, a water-soluble high molecule, a fire retardant, an antistatic agent, a heat stabilizer, a pH adjustor, and an additive added for the purposes of antifreezing, wetting, pigment dispersion, emulsion, anti-skinning, leveling, drying promotion, etc.

For example, the composition of the present invention may include a film-formation assistant other than component (D). Examples of such a film-formation assistant may include an epoxy resin or an epoxysilane. The epoxy resin as the film-formation assistant can be used in the range of 0.1 to 10% by mass (weight), for example, based on the total mass (weight) of the composition of the present invention. The epoxysilane as the film-formation assistant can be used in the range of 0.1 to 5% by mass (weight), for example, based on the total mass (weight) of the composition of the present invention.

The composition of the present invention may include at least one alcohol-based solvent. In the present invention, alcohol-based solvents may be used alone, or multiple alcohol-based solvents may be used in combination. In terms of workability, the solvent is preferably water or a mixed solvent of lower alcohol and water, with example lower alcohols potentially including methanol, ethanol, propanol, etc.

The composition of the present invention may include at least one silicone gum. In the present invention, silicone gums may be used alone, or multiple silicone gums may be used in combination. By blending the silicone gum, the temperature dependence of the viscosity of the composition according to the present invention can be reduced. As the silicone gum, conventionally known silicone gums can be appropriately used, and can be used in the range of 0.001 to 3% by mass (weight), for example, based on the total mass (weight) of the composition of the present invention.

The composition of the present invention may include at least one anti-foam agent. In the present invention, anti-foam agents may be used alone, or multiple anti-foam agents may be used in combination. By blending the anti-foam agent, it is possible to suppress foaming during the application of the composition of the present invention and facilitate application work. As the anti-foam agent, conventionally known anti-foam agents can be appropriately used, and can be used in the range of 0.00001 to 1 (mass) wt %, for example, based on the total mass (weight) of the composition of the present invention.

The composition of the present invention may include at least one thickening agent. In the present invention, thickening agents may be used alone, or multiple thickening agents may be used in combination. By blending the thickening agent, it is possible to increase the viscosity of the composition, reduce dripping during application, and facilitate application work. As the thickening agent, conventionally known thickening agents can be appropriately used, and can be used in the range of 0.001 to 1% by mass (weight), for example, based on the total mass (weight) of the composition of the present invention.

### Preparation Method of the Composition

While the method for preparing a composition according to the present invention is not particularly limited, the composition can be obtained by uniformly mixing/dispersing the abovementioned components (A) to (E) and other water-soluble optional components using mechanical force, and is manufactured, as required, by mixing/dispersing water for preparing a concentration and any other additives. There are no limitations on the mixing method and mixing procedure.

In contrast, it is preferable to create an emulsion liquid containing a curable resin (A) in the form of an aqueous emulsion via an emulsion polymerization method, etc. suitably using an ionic or nonionic surfactant, subsequently add one or more nitrogen-containing heterocyclic compounds, which is component (D), to the emulsion liquid of component (A), and plasticize or stabilize the curable resin in the form of an aqueous emulsion. In this state, when the composition is manufactured by uniformly mixing/dispersing other surfactants, solid particles (C) (suitably, a solid lubricant), and water using mechanical force, it is possible to suppress thickening/gelation of the aqueous coating agent of the present invention and achieve superior handling workability. In particular, in a preferred embodiment of the present invention, the surfactant contains an anionic surfactant different from the surfactant used for the emulsion formation of component (A), and component (D) is a nitrogen-containing heterocyclic compound selected from 1,3-dimethyl-2-imidazolidinone, N-methyl-2-pyrrolidone, and N-ethyl-2-pyrrolidone.

While not limited thereto, example apparatuses for the mixing/dispersing may include a mixer of a propeller type, a paddle type, an anchor type, etc., a homomixer, a homodisper, a homogenizer, a high pressure homogenizer, an ultra-high pressure homogenizer, an ultrasonic homogenizer, a vibration mill, a ball mill, a planetary ball mill, a sand mill, a vacuum emulsion apparatus, a paint shaker, etc.

### Aqueous Lubricating Film Paint Composition

For the case in which at least part of the solid particles, which are component (C), contain a solid lubricant, a lubricating film can be formed on the substrate surface in the aqueous coating agent composition of the present invention, and can be used for the aqueous lubricating film paint. The aqueous lubricating film paint according to the present invention has superior handling workability as an aqueous paint/coating agent, with the lubricating film capable of maintaining superior sliding properties for extended periods of time. Accordingly, the composition of the present invention can yield a lubricating film having high adhesion and superior sliding durability as the lubricating film paint composition.

### Substrate

The aqueous coating agent composition of the present invention, suitably an aqueous lubricating film paint composition, can be cured by heating and drying or irradiation with high energy rays, etc., and used to form a coating film, suitably a lubricating film, with a coating film or a lubricating film having high adhesion capable of being formed on the surface of any substrate.

The material of the substrate is not particularly limited, with examples thereof potentially including metals such as iron, aluminum, and copper, rubber, resin, paper, wood, glass, cement, asphalt, leather, etc. If necessary, the surface of the substrate may be subjected to roughening treatment via electrolytic etching, chemical etching, shot blasting, etc., along with chemical treatment via phosphate, etc., in order to improve the adhesive properties.

In the present invention, a film can be formed on the substrate surface by applying the abovementioned aqueous coating agent composition, suitably the aqueous lubricating film paint composition, onto a substrate surface, and heating the composition and/or irradiating the composition with high energy rays.

While the method for applying the composition onto a substrate surface is not particularly limited, conventionally known application methods, for example, screen printing, spray methods, tumbling methods, immersion methods, brush coating methods, etc. can be used. In particular, for the case in which the composition of the present invention is used as the aqueous lubricating film paint composition, leveling is preferably carried out by leaving the composition to stand for a certain period after application. The lubricity of the obtained film can be improved by leveling. Note that while the substrate may be preliminarily heated during application, the composition is preferably applied at room temperature (approximately 25° C.) in terms of workability. Moreover, in order to remove a solvent such as water from the composition of the present invention, the solvent is preferably removed after leaving the composition to stand at room temperature for 1 to 240 minutes, for example, or heating at 40 to 80° C. for 1 to 60 minutes, for example.

In addition, after removing the solvent, for the case in which the curable resin in the composition is heat curable, the composition film applied onto the substrate surface is subsequently heated to obtain a cured film. The aspect of heating is appropriately adjustable and can be carried out, for example, at 170 to 200° C. for 5 to 90 minutes. As required, the abovementioned removal of a solvent and heating for curing a resin may be simultaneously carried out.

For the case in which the curable resin in the composition is curable by high energy irradiation, the composition applied onto the substrate surface is irradiated with high energy rays such as ultraviolet rays, X rays, or electron rays to obtain a cured film. In terms of safety, etc., ultraviolet rays are preferable as high energy rays. While the irradiation amount of the ultraviolet rays for the case in which the high energy rays are ultraviolet rays is appropriately adjustable, the cumulative light amount is preferably 1000 to 4000 mJ/cm², more preferably 2000 to 3000 mJ/cm².

The present invention also relates to a coating film thus obtained, and specifically, a lubricating film. While the thickness of the film according to the present invention is arbitrary, it can be, for example, 1 to 50 μm, preferably 2 to 25 μm, more preferably 3 to 15 μm.

As the surface roughness of the lubricating film decreases, the resistance and vibration during sliding decreases, while the friction coefficient during sliding decreases, potentially suppressing the generation of frictional sound. While the surface roughness of the lubricating film obtained by the present invention is arbitrary, the arithmetic average roughness Ra based on JIS B0601(2001) can be 0.01 to 10 μm. In particular, from the viewpoint of suppressing frictional sound (rubbing sound generated by contact with other members such as paper, metal plates, and resin plates), the arithmetic average roughness Ra is preferably 0.01 to 5.0 μm, more suitably 0.01 to 1.0 μm.

### Member

The coating film according to the present invention, in particular the member provided with the lubricating film, is useful as a sliding member. While the kind of the sliding member is not particularly limited, examples thereof may include those made of rubber, plastic, or metal.

Examples of the abovementioned rubber sliding member may include timing belts, conveyor belts, body seals for sunroofs, glass runs, weather strips, oil seals, packing, wiper blades, doctor blades, charging rollers, developing rollers, toner feeding rollers, transfer rollers, heat rollers, pressure rollers, cleaning blades, paper feeding rollers, carrying rollers, doctor blades, intermediate transfer belts, intermediate transfer drums, heat belts, driving members for automobiles, for copiers, for printers, etc., sliding members, carrying parts, etc.

Examples of the abovementioned plastic sliding member may include door panels, instrument panels, door locks, bearings, gears, belt tensioners, fixing belts, pressure belts, driving members for automobiles, for copiers, for printers, etc., sliding members, carrying members, etc.

Examples of the abovementioned metal sliding member may include crank shafts, compressor shafts, slide bearings, gears, oil pump gears, pistons, piston rings, piston pins, gaskets, door locks, guide rails, seat belt buckles, brake pads, brake pad clips, brake shims, brake insulators, hinges, screws, pressure pads, driving members for automobiles, for copiers, for printers, etc., sliding members, carrying members, etc.

While the form of the sliding member is not particularly limited, it may be, for example, a fiber shape or fibers. Example fiber-shaped sliding members or sliding members containing fibers may include vehicle sheets, carpets, tire cords, seat belts, etc.

### INDUSTRIAL APPLICABILITY

The application of the aqueous coating agent composition and a member provided with the coating film according to the present invention is not limited, and, for example, they can be used for the application of electric appliances, ships, railroads, aircrafts, machines, structures, automobile repairs, automobiles, construction, construction materials, fibers, leather, stationery, woodwork, furniture, general merchandise, steel plates, cans, electronic substrates, electronic components, printing, etc. In particular, the present invention can be employed as various products provided with the lubricating film, and in particular, can be suitably employed to manufacture a sliding member provided with the lubricating film.

### EXAMPLES

Hereinafter, while the present invention will be described with reference to examples, the present invention is not limited thereto.

### Examples 1 to 7 and Comparative Examples 1 to 8

Each component was mixed at the ratio shown in Tables 1 and 2 to obtain the aqueous coating agents (aqueous lubricating film paint compositions) of Examples 1 to 7 and Comparative Examples 1 to 8.

Note that the numeric values shown in Tables 1 and 2 denote parts by mass. Further, the aqueous polyurethane resin/aqueous polyolefin resin in the tables is described as a binder, which is component (A) of the present invention, and described as parts by mass (100 parts by mass) of solid content, while water in the form of an aqueous emulsion is described as that contained in water component (E).

### Flow Stability

The flow stability of a coating agent was determined using the following criteria, and shown together in Table 1 (Examples 1 to 7) and Table 2 (Comparative Examples 1 to 8).

⊚: highly stable
∘: stable but thickens
Δ: thickens and gelates after 24 hours
x: instantly gelates
xx: a solid lubricant cannot be dispersed and floats and separates, or precipitates

Moreover, each component and term used in the tables is as follows. Note that in the tables, parts by mass in “water” is the sum of components derived from other raw material components.

Aqueous polyurethane resin: aqueous emulsion of aliphatic system polyurethane resin (solid content: 40 wt %)
Aqueous polyolefin resin: aqueous emulsion of maleic anhydride-modified 1-propene-1-butene copolymer (solid content: 30 wt %)
Sodium dodecylbenzene sulfonate: solid content of 50 wt %, PTFE (polytetrafluoroethylene) produced by NOF Corporation Powder: spherical polytetrafluoroethylene resin fine particles having a median diameter of 3 to 5 μm (solid content: 100 wt %) by a laser diffraction scattering type particle size distribution measurement method
PTFE (polytetrafluoroethylene) dispersion: spherical polytetrafluoroethylene resin fine particles having a median diameter of 0.10 to 1.00 μm (solid content: 50 wt %) by a laser diffraction scattering type particle size distribution measurement method
Agitan 295: anti-foam agent produced by MUNZING CHEMIE GMBH
1,3-dimethyl-2-imidazolidinone: DMEU produced by Kawaken Fine Chemicals Co., Ltd.
N-methyl-2-pyrrolidone: N-methyl-2-pyrrolidone produced by BASF Japan Ltd.
N-ethyl-2-pyrrolidone: N-ethyl-2-pyrrolidone produced by BASF Japan Ltd.
Triethanolamine: triethanolamine, >=98.0%, produced by Wako Pure Chemical Industries, Ltd., and produced by Sigma-Aldrich Japan
Diethanolamine: diethanolamine, 99%, produced by Wako Pure Chemical Industries, Ltd.
γ-butyrolactone: gamma butyrolactone, 99.5% or more, produced by Mitsubishi Chemical
Benzyl benzoate: benzyl benzoate Wako Special Grade produced by Wako Pure Chemical Industries, Ltd.
Methyl ethyl ketone: methyl ethyl ketone acrylonitrile-butadiene-styrene copolymer (ABS) produced by Wako Pure Chemical Industries, Ltd.
Resin plate: Tough Ace EAR-003 produced by Sumitomo Bakelite 1 Co., Ltd.
SPCC-SB steel plate: SPCC-SB produced by Nission Steel Co., Ltd.

### Example 1

At the blending ratio shown in Table 1, 1,3-dimethyl-2-imidazolidinone was added to an aqueous polyurethane resin emulsion (resin solid content: 40%) as a solvent, stirred, mixed, and dissolved. Subsequently, sodium dodecylbenzenesulfonate, which is an anionic surfactant, was added under stirring and dissolved, after which a PTFE powder was dispersed as a solid lubricant. After adding an anti-foam agent, the obtained mixture was mixed and stirred at 600 rpm for 30 minutes to obtain an aqueous coating agent composition.

### Example 2

An aqueous coating agent composition was obtained by the same method as in Example 1, except that an aqueous polyolefin resin emulsion (resin solid content: 30%) was used at the blending ratio shown in Table 1.

### Examples 3 to 5

An aqueous coating agent composition was obtained by the same method as in

Example 1, except that a PTFE dispersion was used as the solid lubricant at the blending ratio shown in Table 1, and 1,3-dimethyl-2-imidazolidinone was used alone as the solvent, or used in combination with benzyl benzoate.

### Examples 6 to 7

An aqueous coating agent composition was obtained by the same method as in Example 1, except that N-methyl-2-pyrrolidone or N-ethyl-2-pyrrolidone was used as the solvent at the blending ratio shown in Table 1.

### Comparative Examples 1 to 2

An aqueous coating agent composition was obtained by the same method as in Example 1, except that triethanolamine or diethanolamine was used as the solvent at the blending ratio shown in Table 2. When the obtained mixture was left to stand at room temperature, it thickened with time and entered a gelled state after 24 hours in which it did not flow.

### Comparative Examples 3 to 4

When a mixture, obtained by the same method as in Example 1 except that γ-butyrolactone or benzyl benzoate was used as the solvent at the blending ratio shown in Table 2, was stirred and mixed at 600 rpm, it rapidly thickened and entered a gelled state in which it did not flow.

### Comparative Example 5

When methyl ethyl ketone was added to an aqueous polyurethane resin emulsion (resin solid content: 40%) as the solvent at the blending ratio shown in Table 2, stirred, and mixed, an aggregate of the resin emulsion was generated and precipitated.

### Comparative Example 6

A mixture was obtained by the same method as in Example 1, except that a PTFE dispersion was used as the solid lubricant while benzyl benzoate was used as the solvent, at the blending ratio shown in Table 2; and when the mixture was stirred and mixed at 600 rpm, an aggregate of the resin emulsion was generated and precipitated.

### Comparative Example 7

When a mixture, obtained by the same method as in Example 1 at the blending ratio shown in Table 2 in a state without using any solvent, was stirred and mixed at 600 rpm, it rapidly thickened and entered a gelled state in which it did not flow.

### Comparative Example 8

When a mixture, obtained by the same method as in Example 1 at the blending ratio shown in Table 2 in a state without using a surfactant, was stirred and mixed at 600 rpm, the PTFE of a solid lubricant was incapable of being sufficiently dispersed, resulting in the generation of a floating separation matter and a precipitate.

### Lubricating Film Formation

The aqueous coating agent composition obtained in the example of Table 1 was spray-coated on an acrylonitrile-butadiene-styrene copolymer (ABS) resin plate or SPCC-SB steel plate (SPCC steel plate) such that the film thickness after drying was 10 to 20 μm. In order to evaporate the solvent and water, it was left to stand at 25° C. for 60 minutes, dried, and cured to create a lubricating film. Note that in the comparative examples, because a lubricating film was incapable of being formed by gelation, etc., it is described as “unmeasurable” in Table 2.

Regarding each example, the friction coefficient of the obtained lubricating film was measured for an ABS resin plate. Moreover, grid adhesion of the obtained lubricating film was evaluated for an ABS resin plate and an SPCC steel plate. The results are also shown in Table 1.

### Evaluation Method

### Friction Coefficient Measurement

Using a reciprocating friction abrasion tester for reciprocation by rotationally moving a roller (with a vertical load applied thereto) with respect to each test piece (ABS) (with the lubricating film formed therein), the dynamic friction coefficient (unit: μ) during the sliding with respect to an SUJ2 steel roller was measured under the conditions of a sliding speed of 0.2 m/s, a load of 100 g, and a sliding distance (stroke) of 40 mm, and determined using the following criteria.

⊚: 0.10 to 0.19
∘: 0.20 to 0.29
Δ: 0.30 to 0.39
x: 0.40 to 0.49

### Grid Adhesion Test

The film of each test piece (ABS resin plate, SPCC steel plate) in which the lubricating film was formed was cut into a grid of 100 squares, and Scotch tape (registered trademark) peeling testing was carried out. The number of lattices in which the film remained among 100 squares of the grid was confirmed and a determination made using the following criteria.

⊚ (100)
∘ (90 to 99)
Δ (50 to 89)
x (0 to 49)

TABLE 1

| | | Example No. | | | | | | |
|---|---|---|---|---|---|---|---|---|
| Composition | | 1 | 2 | 3 | 4 | 5 | 6 | 7 |
| (A) Binder | Aqueous polyurethane resin | 100 | 0 | 100 | 100 | 100 | 100 | 100 |
| (Solid content) | Aqueous polyolefin resin | 0 | 100 | 0 | 0 | 0 | 0 | 0 |
| (B) Surfactant | Sodium dodecylbenzene sulfonate | 30 | 30 | 5 | 30 | 30 | 30 | 30 |
| (C) Solid | PTFE powder (average particle | 130 | 130 | 0 | 0 | 0 | 130 | 130 |
| lubricant | diameter D50 3-5 μm) | | | | | | | |
| | PTFE dispersion(average particle | 0 | 0 | 40 | 130 | 130 | 0 | 0 |
| | diameter D50 0.1-1 μm) | | | | | | | |
| Anti-foam agent | Agitan 295 | 0.25 | 0.25 | 0.25 | 0.25 | 0.25 | 0.25 | 0.25 |
| Solvent | (D) 1,3-dimethyl-2-imidazolidinone | 7.5 | 7.5 | 7.5 | 2.5 | 7.5 | 0 | 0 |
| | (D2) N-methyl-2-pyrrolidone | 0 | 0 | 0 | 0 | 0 | 7.5 | 0 |
| | (D3) N-ethyl-2-pyrrolidone | 0 | 0 | 0 | 0 | 0 | 0 | 7.5 |
| | Triethanolamine | 0 | 0 | 0 | 0 | 0 | 0 | 0 |
| | Diethanolamine | 0 | 0 | 0 | 0 | 0 | 0 | 0 |
| | γ-butyrolactone | 0 | 0 | 0 | 0 | 0 | 0 | 0 |
| | Benzyl benzoate | 0 | 0 | 0 | 0 | 7.5 | 0 | 0 |
| | Methyl ethyl ketone | 0 | 0 | 0 | 0 | 0 | 0 | 0 |
| | (E) Water | 600 | 600 | 350 | 600 | 600 | 600 | 600 |
| Liquid | Stability | ⊚ | ⊚ | ⊚ | ⊚ | ⊚ | ⊚ | ⊚ |
| properties | | | | | | | | |
| Lubricating film | Friction coefficient (ABS) | ⊚ | ◯ | ◯ | ⊚ | ⊚ | ⊚ | ⊚ |
| properties | Grid adhesion Substrate: | ⊚ | ◯ | ⊚ | ⊚ | ⊚ | ⊚ | ⊚ |
| | ABS (upper) | ⊚ | ◯ | ⊚ | ⊚ | ⊚ | ⊚ | ⊚ |
| | Substrate: | | | | | | | |
| | SPCC steel plate (lower) | | | | | | | |

TABLE 2

| | | Comparative Example No. | | | | | | | |
|---|---|---|---|---|---|---|---|---|---|
| Composition | | 1 | 2 | 3 | 4 | 5 | 6 | 7 | 8 |
| (A) Binder | Aqueous polyurethane resin | 100 | 100 | 100 | 100 | 100 | 100 | 100 | 100 |
| (Solid content) | Aqueous polyolefin resin | 0 | 0 | 0 | 0 | 0 | 0 | 0 | 0 |
| (B) Surfactant | Sodium dodecylbenzene | 30 | 30 | 30 | 30 | 30 | 30 | 30 | 0 |
| | sulfonate | | | | | | | | |
| (C) Solid | PTFE powder (average particle | 130 | 130 | 130 | 130 | 130 | 0 | 130 | 130 |
| lubricant | diameter D50 3-5 μm) | | | | | | | | |
| | PTFE dispersion(average particle | 0 | 0 | 0 | 0 | 0 | 130 | 0 | 0 |
| | diameter D50 0.1-1 μm) | | | | | | | | |
| Anti-foam agent | Agitan 295 | 0.25 | 0.25 | 0.25 | 0.25 | 0.25 | 0.25 | 0.25 | 0.25 |
| Solvent | (D) 1,3-dimethyl-2- | 0 | 0 | 0 | 0 | 0 | 0 | 0 | 7.5 |
| | imidazolidinone | | | | | | | | |
| | (D2) N-methyl-2-pyrrolidone | 0 | 0 | 0 | 0 | 0 | 0 | 0 | 0 |
| | (D3) N-ethyl-2-pyrrolidone | 0 | 0 | 0 | 0 | 0 | 0 | 0 | 0 |
| | Triethanolamine | 7.5 | 0 | 0 | 0 | 0 | 0 | 0 | 0 |
| | Diethanolamine | 0 | 7.5 | 0 | 0 | 0 | 0 | 0 | 0 |
| | γ-butyrolactone | 0 | 0 | 7.5 | 0 | 0 | 0 | 0 | 0 |
| | Benzyl benzoate | 0 | 0 | 0 | 7.5 | 0 | 7.5 | 0 | 0 |
| | Methyl ethyl ketone | 0 | 0 | 0 | 0 | 7.5 | 0 | 0 | 0 |
| | (E) Water | 600 | 600 | 600 | 600 | 600 | 600 | 600 | 600 |
| Liquid | Stability | Δ | Δ | X | X | X | X | X | XX |
| properties | | | | | | | | | |

| Lubricating film | Friction coefficient (ABS) | Unmeasurable |
|---|---|---|
| properties | Grid adhesion Substrate: | |
| | ABS (upper) | |
| | Substrate: | |
| | SPCC steel plate (lower) | |

1. An aqueous coating agent composition comprising:
(A) a curable resin in the form of an aqueous emulsion;
(B) a surfactant;
(C) solid particles;
(D) one or more nitrogen-containing heterocyclic compounds; and
(E) water.

2. The aqueous coating agent composition according to claim 1, wherein component (D) is a nitrogen-containing heterocyclic compound represented by any one of structural formulae (D-1) to (D-3): 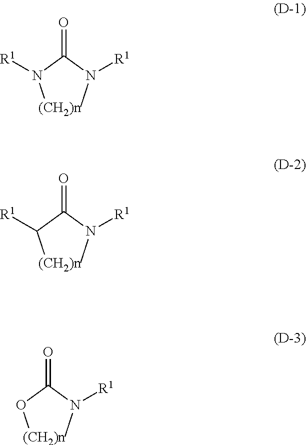
wherein each R¹ is independently a hydrogen atom or an alkyl group having a 1 to 9 carbon atoms, and n is a number in the range of 1 to 10.

3. The aqueous coating agent composition according to claim 1, wherein component (D) is one or more nitrogen-containing heterocyclic compounds selected from the group of 1,3-dimethyl-2-imidazolidinone, N-methyl-2-pyrrolidone, N-ethyl-2-pyrrolidone, N-methyl-3-methyl-2-pyrrolidone, cyclohexyl pyrrolidone, 2-oxazolidone, 3-methyl-2-oxazolidone, and combinations thereof.

4. The aqueous coating agent composition according to claim 1, wherein component (B) contains an anionic surfactant different from a surfactant used for the emulsion formation of component (A), and component (D) is 1,3-dimethyl-2-imidazolidinone.

5. The aqueous coating agent composition according to claim 1, containing, with respect to 100 as the product mass of solid content of component (A), 0.1 to 50 parts by mass of component (B), 5 to 200 parts by mass of component (C), 1 to 20 parts by mass of component (D), and 50 to 1000 parts by mass of component (E).

6. The aqueous coating agent composition according to claim 1, wherein component (A) is selected from the group of a polyacryl resin, a polyurethane resin, a polyolefin resin, an epoxy resin, a silicone resin, a polyamide-imide resin, in the form of an aqueous emulsion, or a modified product thereof or a mixture thereof.

7. The aqueous coating agent composition according to claim 1, wherein at least part of component (C) is a solid lubricant.

8. The aqueous coating agent composition according to claim 1, wherein component (C) contains a solid lubricant selected from a fluorine resin, a polyethylene resin, a polyamide resin, molybdenum disulfide, graphite, aluminum oxide, boron nitride, zinc oxide, or a mixture thereof.

9. An aqueous lubricating film paint composition comprising the aqueous coating agent composition according to claim 1.

10. The aqueous coating agent composition according to claim 3, wherein component (D) is 1,3-dimethyl-2-imidazolidinone.

11. A coating film, obtained by curing the aqueous coating agent composition according to claim 1.

12. A member provided with a coating film, obtained by curing the aqueous coating agent composition according to claim 1.

13. The coating film according to claim 11, further defined as a lubricating film.

14. The member according to claim 12, further defined as a sliding member.

15. A method for forming a coating film on a substrate surface, the method comprising:
applying the aqueous coating agent composition according to claim 1 onto a substrate surface; and
drying and/or irradiating the applied composition with high energy rays.

16. The aqueous coating agent composition according to claim 10, containing, with respect to 100 as the product mass of solid content of component (A), 1 to 20 parts by mass of component (D).
